(19) United States
(12) Patent Application Publication
(10) Pub. No.: US 2011/0040595 A1
(43) Pub. Date: Feb. 17, 2011

(54) REAL-TIME SERVICE MANAGEMENT AND DISPATCH SYSTEM

(76) Inventors: Y. Hong Chou, Fountain Valley, CA (US); Tom Farmakis, Sharpsburg, GA (US); Thomas R. Knowles, Peachtree City, GA (US)

Correspondence Address: Innovation Capital Law Group, LLP, 19900 MacArthur Blvd., Suite 1150, Irvine, CA, 92612, US

(21) Appl. No.: 12/540,031

(22) Filed: Aug. 12, 2009

(51) Int. Cl. G06Q 10/00; G06F 17/30

(52) U.S. Cl. 705/8; 707/E17.005

(57) ABSTRACT

A real-time management and dispatch system includes a controller configured to control data flow and processing of management and dispatch operations. A database server is configured to control storage, organization, retrieval, and distribution of management and dispatch data. At least one workstation is configured for accessing dispatch functions and management functions. At least one Global Positioning System (GPS) enabled handheld device is configured to receive and transmit dispatch information over a local wireless communication network. The local wireless communication network provides real-time information transmission between the controller, at least one work station, and the at least one handheld device.

### BACKGROUND

1. Field of the Invention

The present invention relates generally to service management and dispatch systems and, more particularly, to real-time travel service management and dispatch systems.

2. Description of the Related Art

Aircraft require several types of services between flights, e.g., the cabin needs to be cleaned thoroughly seat by seat, water needs to be replenished and carefully checked, lavatories need to be cleaned and supplies replenished, etc. As the airline industry must minimize the amount of time that aircraft remain inactive at a gate, these services must be conducted within a very narrow time window between the arrival of an aircraft at the gate and its departure to the next destination.

The efficiency of aircraft services is critical to the operations of carriers. A delay in any type of aircraft service causes a flight to be delayed for departure, thereby bringing a significant financial burden to the carrier. A service delay may trigger a series of chain effects with substantial costs: passengers may miss their connecting flights at the next airport, the arrival gate for the next destination may need to be relocated, the next incoming flight originally scheduled for arrival at the gate may need to be relocated to another gate, passenger services originally scheduled at one gate may need to be relocated to another gate, etc. The efficiency of aircraft services is extremely critical to airline operations especially when there are multiple flight delays caused by weather conditions. During bad weather, the arrangement of aircraft services has to be coordinated and changes made within a very short time frame in response to flight delays, aircraft changes, and even just a simple gate change.

At present, aircraft service providers depend on hardcopy paperwork and, at most, digital spreadsheets, to conduct management functions of assignment, relocation, and reassignment of service tasks. There is no automated solution to streamline the operation. A dispatcher has no idea where a service crew is located at any moment of time. In order to know the status of a crew and where the crew is located, the dispatcher needs to use a two-way radio or a cellular phone and ask the team leader about the status of assignment and current location. In larger airports where many flights arrive and depart within a short time window, any change in flight schedule or gate causes a problem for dispatchers as they need to respond to sudden changes and also coordinate among themselves.

One of the major difficulties for aircraft service providers is that there is no reliable mechanism available for assessing the efficiency and productivity of service crews. Without a proper real-time reporting mechanism, there is no accountability of which team provided services to support which aircraft. Managers have to rely on the verbal reports or explanations from service crews, which can sometimes be misleading. Dispatchers have no idea about the current locations of available service crews. It is not uncommon for a dispatcher to assign a team on one side of an airport terminal to the other side while there are other service crews that are available for assignment and are much closer to that gate.

Service crews need to replenish supplies between assignments from time to time. The time spent on replenishing supplies must be minimized as such activity is non-productive although it is necessary. Some teams may take longer than other teams, which could be simply because that team is farther away from supply stations than other teams, or because that team does not act fast enough. Without any information about who is where at any time, there is no way to know how to improve the efficiency of service teams and enhance productivity.

Another difficulty for providers of aircraft services is that, at present, service records are not tied to billing records. Without a reliable and automated reporting mechanism, it is impossible to obtain real-time service records and link such records to the billing system. Without a system that can electronically generate reports based on real-time service records, there are frequent disputes between service providers and carriers about services performed and services changed. The provider tends to find it very difficult to prove their cases in any dispute about services, even though they have indeed provided the service according to specifications.

### BRIEF SUMMARY

One aspect of an embodiment of the invention includes a real-time management and dispatch system including a controller configured to control data flow and processing of management and dispatch operations. A database server is configured to control storage, organization, retrieval, and distribution of management and dispatch data. At least one workstation is configured for accessing dispatch functions and management functions. At least one Global Positioning System (GPS) enabled handheld device is configured to receive and transmit dispatch information over a local wireless communication network. The local wireless communication network provides real-time information transmission between the controller, at least one work station, and the at least one handheld device.

Another aspect of an embodiment of the invention provides a real-time management and dispatch system method. The method includes controlling data flow and processing of management and dispatch operations with a controller processor; storing, organizing, retrieving and distributing management and dispatch data using a database server; accessing dispatch functions and management functions through a workstation; and receiving and transmitting dispatch information over a local wireless communication network using a wireless handheld device. Real-time information is transmitted between the controller processor, the work station, and the handheld device.

A further aspect of an embodiment of the invention provides a computer program product for providing management and dispatching aircraft services, comprising a computer usable medium including a computer readable program comprising program instructions, wherein the computer readable program when executed on a computer causes the computer to: control data flow and processing of management and dispatch operations with a controller processor, store, organize, retrieve and distribute management and dispatch data using a database server, access dispatch functions and management functions through a workstation, and receive and transmit dispatch information over a local wireless communication network using a wireless handheld device. Real-time information is transmitted between the controller processor, the work station, and the handheld device.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates a real-time management and dispatch system according to one embodiment of the invention;

FIG. 2 illustrates an exemplary display of flight information according to one embodiment of the invention;

FIG. 3 illustrates an exemplary display interface for importing flight information according to one embodiment of the invention;

FIG. 4 illustrates an exemplary display interface for delay reporting according to one embodiment of the invention;

FIG. 5 illustrates an exemplary display interface for service log reporting according to one embodiment of the invention;

FIG. 6 illustrates an exemplary display interface for dispatch operations according to one embodiment of the invention;

FIG. 7 illustrates a service flow diagram according to one embodiment of the invention; and

FIG. 8 illustrates a block diagram of a process according to one embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc. The description may disclose several preferred embodiments for real-time service management and dispatch systems, devices, and methods, as well as operation and/or component parts thereof. While the following description will be described in terms of real-time service management and dispatch devices, systems and methods for clarity and placing the invention in context, it should be kept in mind that the teachings herein may have broad application to all types of systems, devices and applications.

Some embodiments of the invention incorporate Geographic Information Systems (GIS), Digital Mapping, Global Positioning System (GPS), asset tracking with handheld devices, and Wireless Communications technology into a system designed specifically for aircraft services. The implementation of these technologies significantly improves the efficiency in dispatching of service crews and overall management of aircraft services in response to the dynamics of flight delays, aircraft changes, short-noticed relocations of terminals and gates, and constantly moving service crews.

One embodiment of the invention includes an aircraft service dispatch and management system. Some embodiments use a database that stores and organizes the records related to different types of aircraft services provided by service crews. Management features for task assignment are based on the regular flight schedule, and dispatch functions to support real-time changes due to flight delays and gate relocations are incorporated according to one embodiment of the invention. In one embodiment of the invention, constant communications through a wireless network (e.g., a Wireless Local Area Network (WLAN)) between dispatchers and service crews enhance the efficiency of task assignment especially at the occurrence of flight delays and gate changes. The system provides the capability for the dispatchers to see the current location of each service crew and gate locations, where aircrafts requiring services are located in real-time. Various reports may be generated in real-time, not only to support management in assessing job performance of service crews, but also to provide information needed as input to the billing system.

In one embodiment of the invention, the system stores historical records that can be used to evaluate the movements of a service crew, the inactive wait times, gate locations where services were provided, the time a service started and ended, etc. Historical records of the services performed by each crew may be obtained and analyzed for improvements of efficiency. A dynamic, GIS-based dispatch system allows the dispatcher to respond to short-noticed changes immediately instead of competing on a congested radio frequency. The system provides methods for reassigning crews in response to flight changes and gate changes in real-time. Upon completion of a task on an aircraft, the crew leader alerts (e.g., presses a button on the handset) the system by signaling completion of the current assignment, and the service crew is automatically updated from the “assigned” to “available for assignment” status. The dispatcher is able to see the up-to-the-minute status of the crew and its current location on a display, and, unless the crew signals the need to replenish supplies, dispatch the crew for the next assignment based on the current location of the crew and the closet gate where the service is needed. The system also provides a robust reporting function enabling a management team to generate service reports, evaluate service performance, identify the root cause of any problem with the service, correct systemic deficiencies, and link service records to the billing system.

It should be noted that the embodiments relate to handling of aircraft services, as well as dispatch service to other areas of airline operations at airports, including cabin services, cargo operations, etc. Many of the fields terminology may vary for different airline carriers or at different airports. Data types may also vary from system to system.

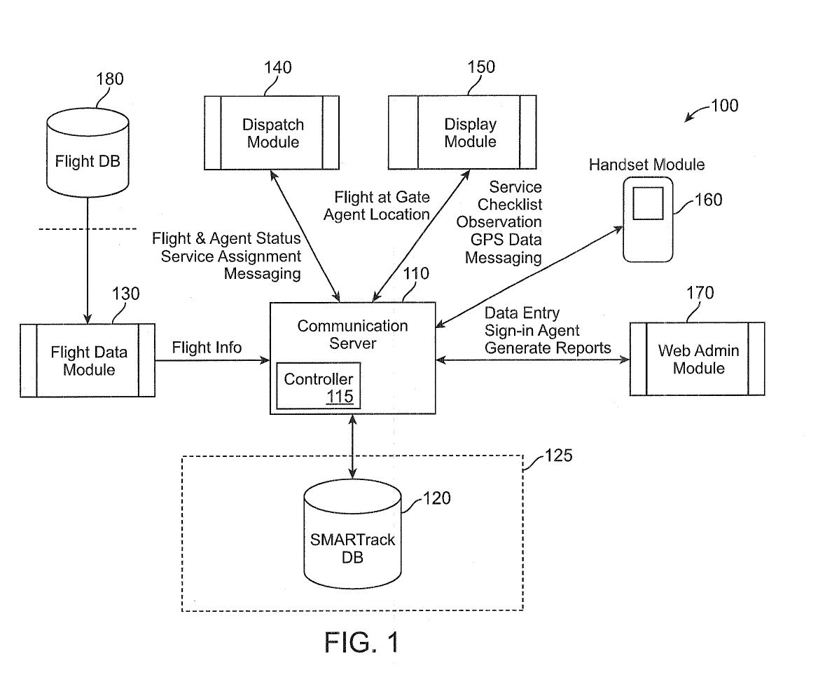

FIG. 1 illustrates a real-time management and dispatch system 100 according to one embodiment of the invention. In one embodiment of the invention, the Communication Server 110 includes a controller processor 115 and controls the communications between different modules and the database. The carrier's flight information is retrieved from the database 120 through the Flight Data Module 130 via the Communication Server 110. In some embodiments of the invention, a database server 125 is included in the system 100 to provide database operations for the databases 120.

In one embodiment of the invention, the Dispatch Module 140 obtains current status of flights, agents, and services through the Communication Server 110. Service assignments and messaging also utilize the same channel of communication. The Display Module 150 connects to the Communication Server 110 to obtain information of agent locations and the gate locations with aircrafts requiring services. The Handset Module 160 communicates with the Communication Server 110 for service assignments, updated flight status, Global Positioning System (GPS) data and constant communications with the dispatch module 140. The Web Administrator Module 170 communicates with the Communication Server 110 to handle functions of system administration and report generation.

The system 100 provides at least a data import function to import data from at least one single source of flight information. In one embodiment of the invention, additional means for the system 100 is used to obtain the information from each carrier's network. The source file can be in a fixed format, such as an Excel or other database program file formats. FIG. 2 illustrates an exemplary display of flight information. As illustrated, information may be imported where the first row is the header with the remaining rows flight information. Other types of data files or data tables, formats, etc. may be supported by other embodiments of the invention. As illustrated in FIG. 2 an exemplary sample containing the flight information provided by a carrier is displayed. In this example, the flight information includes operating days, scheduled time and gates of inbound and outbound flights.

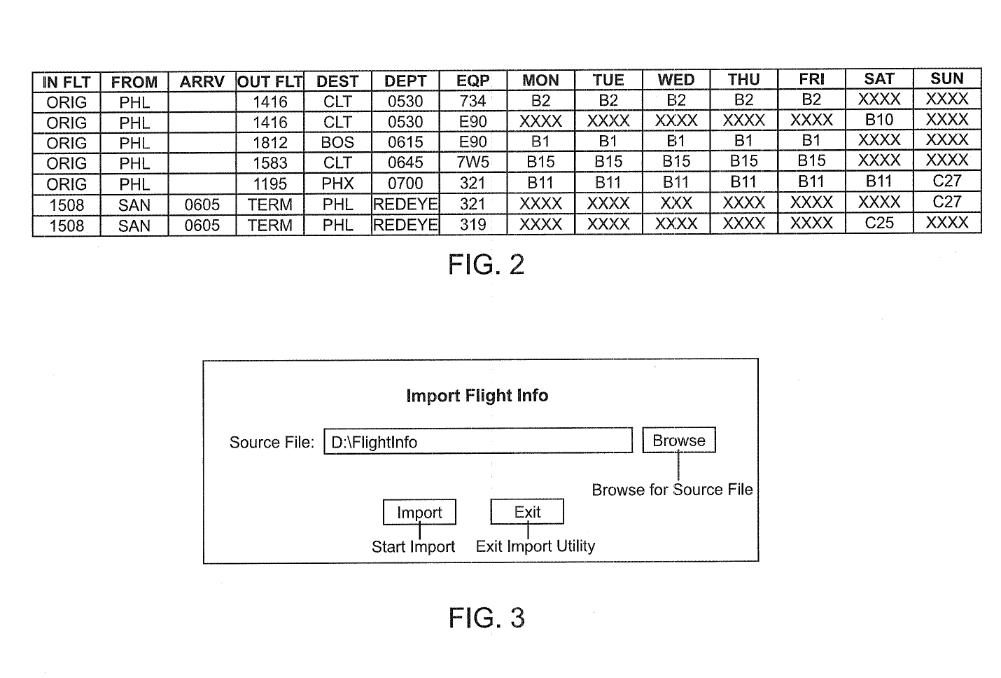

In one embodiment of the invention, the system 100 provides one or more display windows, graphical user interfaces (GUIs), etc. for dispatchers to manually enter flight information or edit flight information when changes to the flight information may occur. FIG. 3 illustrates an exemplary window/GUI for entering flight data into the system 100. The flight information may include at least the following fields: Flight, Date, Gate, Flight Type, A/C Type (the type of aircraft), Tail# (a unique identifier of each aircraft), Destination, Extended Operations (ETOPS), Targeted Performance Flights, Days of Operation (the days of the week that this flight operates), etc.

In one embodiment of the invention, a status window/GUI lists all flights to be served, in order, by either arrival time or departure time. In another embodiment of the invention, domestic flights and international flights are marked differently for distinguishability (e.g., different colors, fonts, etc.). A status window shows blocks of service of each flight. Each block represents one of the three general service types: Clean, Lavatory, and Water. In one embodiment of the invention, blocks are ordered by projected service completion time, i.e., whichever service is more urgent. Additional service types may be included as required.

In one embodiment of the invention, whenever any one of the service types is done, the block corresponding to the specific service type is removed from the status window/GUI, thus the dispatcher always sees only the tasks that are not completed yet. The system 100 provides a menu item to allow for a user to adjust the setting to select any one or more of the service types. If any service type is not selected, the data of that specific service type will not be included in the group. Whenever there is a callback, i.e., a gate agent calls back the crew as they consider the job not completed yet and the crew has already left and marked as job completed, the window/GUI will retrieve the specific service type and the associated flight record. The service time is included in the window. Callbacks may involve the assignment of the previous task to another crew, thus the assigned crew for each callback and the additional service time is included. Each block will show the crew that is specifically assigned to the task.

In one embodiment of the invention a separate window/GUI lists all the available crews that are not assigned any task at that moment. Whenever an assignment is done, the crew will be moved to the available list based on the order they finished the previous job assignments. Due to the different qualification and requirements, international crews can be made available for both domestic flights and international flights, while domestic crews can only be assigned to domestic flights. Whenever a crew is assign to a job, the crew will be marked in the window/GUI of the assigned task and removed from the list of available crews. All crews are classified into either domestic or international, and also classified into clean, lavatory, water, or any other additional type of services. The classifications are mutually exclusive, thus no crew will belong to multiple categories according to one embodiment of the invention.

The system 100 allows for the user to generate additional daily reports and monthly reports, generate daily reports at anytime of the day, select one or more dates and generate daily reports of the selected dates. In one embodiment of the invention, daily reports will comprise fields of input flight information, plus additional fields including: Original Service, Callback Service, Reason for Callback, Tower, Person, Employee#, MTC (maintenance) Problem, Truck Number, Time On, Time Off, and GPS Validation. Other embodiments may include other fields as required. The reports can be used for both crew management and billing purposes. In addition to the above reports, the system 100 may receive the service logs based on the data entered on the mobile application with the forms of Service Check List for all the available types of services, such as clean, lavatory, and water services, and also for different types of aircrafts that the carrier uses at any airport. At any time, the user may print out the service logs of each form that is transmitted from the handset including handset module 160 through wireless communication. The service logs to be used for FAA reports will include the name and entered fields of each form, organized by date and flight number according to one embodiment of the invention.

In one embodiment of the invention, the administration site is a web-based site that includes the following components and information: Basic System Setup: Aircraft Type, Aircraft (Tail#), Flight Schedule, Master Station (ETOPS Destination, etc.), GSE (Ground Support Equipment), Handset(s), Employee(s) (System Admin/Supervisor/Agent), Canned Messages (predetermined messages to ease communication and increase efficiency), MST (Minimum service times).

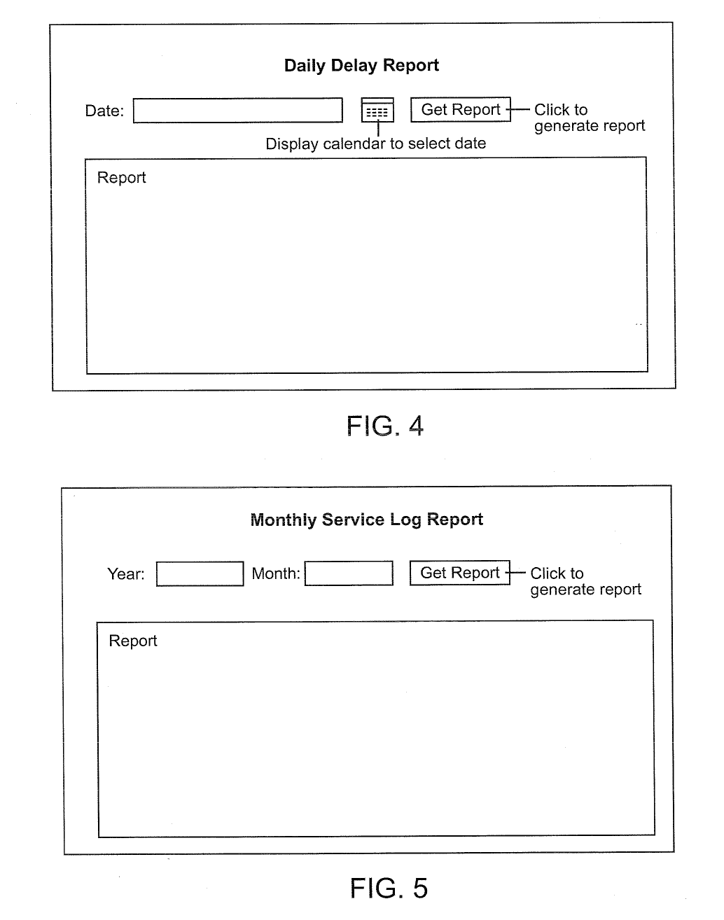

In one embodiment of the invention, the Reports comprise at least the following: Daily Delay Report (see e.g., FIG. 4), On-Time Performance Report, Monthly Service Billing Report, Monthly Service Log Report (see e.g., FIG. 5), and Monthly ETOPS/Targeted Performance Compliance Report.

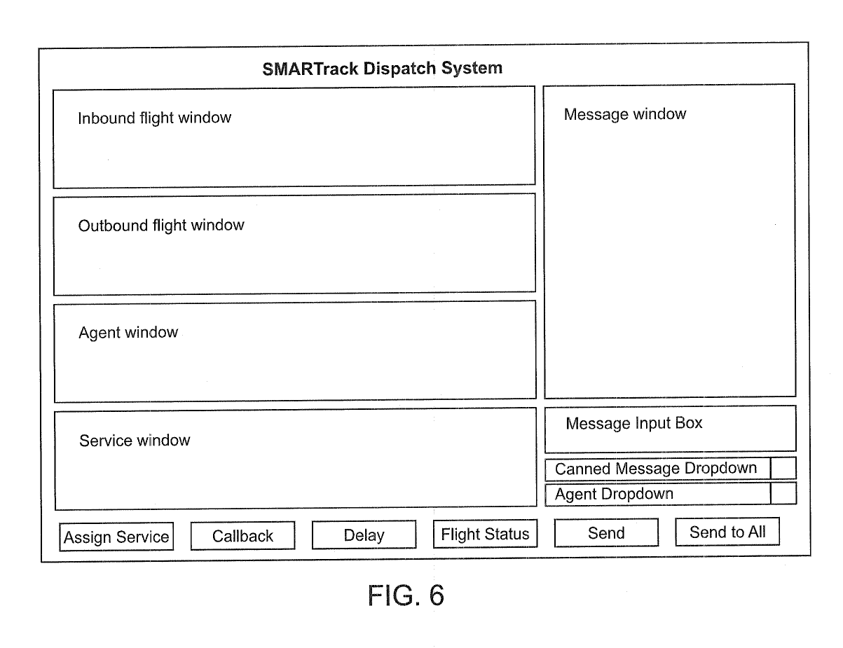

In one embodiment of the invention, the Dispatch System comprises at least the following: Sign in/Sign off crew (Assign Personal Digital Assistant (PDA) or similar handset and GSE), Display Inbound/Outbound flights that need service based on flight schedule (see e.g., FIG. 6), Display on duty agents and availability (see e.g., FIG. 6, agents window), Dispatch agent for service (Cabin—Turn Clean, Red Eye, Long Haul, International & RON/Water/LAV). The system 100 provides flexibility to dispatch a supervisor in case of emergency (see e.g., FIG. 6, agents window), Update flight status changes (Schedule, Gate and Tail#), Callback service, Record delay, Canned messaging (send and receive) (see e.g., FIG. 6, canned message dropdown menu), MTC problem alert, GSE Notification (e.g., remind agent to restock the truck).

As illustrated, FIG. 3 shows a sample window/GUI for importing or adding flight information to the system 100 by the flight data module from the flight information database 180 or manually inputted by a user. The user may simply browse for the flight information source file in the format, as exemplified in FIG. 2, and then select/click an ‘Import’ button on the window/GUI interface to transform flight information to a format useable by the system 100 and store the data in database 120. In one embodiment of the invention, during the process of flight data import, the system 100 will generate an error log if the destination of a flight is not in the Master Station list.

FIG. 4 illustrates an exemplary window/GUI for displaying a daily delay report according to one embodiment of the invention. It should be noted that other formats may be implemented including at least the basic delay information. As illustrated, a sample window/GUI includes functionality to generate daily delay reports. Different types of reports may be generated by clicking the proper buttons on the window/GUI. The exemplary display providing the Daily Delay Report lists the delays on any specific day. A user may simply specify a date and select/click the ‘Get Report’ button to generate the desired daily delay report.

FIG. 5 illustrates an exemplary window/GUI for generating and displaying (or printing, emailing, etc.) Monthly Service Log Reports according to one embodiment of the invention. A user may specify the year and month and then select/click the ‘Get Report’ button to generate the desired service log report.

FIG. 6 illustrates an exemplary dispatch window/GUI according to one embodiment of the invention. The Inbound Flight window displays inbound flights and the associated required services based on arrival time and service time. The Outbound Flight window displays departure flights and their corresponding required services based on departure time and service time. The Agent window displays the list of on-duty agents and their respective availability. The Service window displays current services and the progress of service according to one embodiment of the invention.

In one embodiment of the invention, the Message window/GUI displays messages from agent to dispatcher. In another embodiment of the invention, the ‘Assign Service’ button is used for service assignment, and the ‘Callback’ button allows a dispatcher to call back a team to re-do a completed service. in one embodiment of the invention, the ‘Delay’ button is used for the dispatcher to record a service delay and the ‘Flight Status’ button is used for updating current flight status including gate change, time change and canceled flights. In another embodiment of the invention, the dispatcher may create messages by typing texts in the Message Input Box, or by selecting from the Canned Message Dropdown menus, any desired canned messages that are available for selection. In another embodiment of the invention, the dispatcher may specify a recipient of the message by selecting an agent from an Agent Dropdown menu and selecting/clicking the ‘Send’ button or selecting/clicking the ‘Send to All’ button to send the message to all on-duty agents.

In one embodiment of the invention, the leader of each crew, or the driver of each truck, is assigned a GPS-enabled handset loaded with the handset module 160. At any given time, a handset is assigned to the leader of a crew and is associated with the truck of that team. It should be noted that it is possible that a leader may not be associated with any truck as some crews may work on foot. Therefore, the association between a crew leader and a truck is for information purposes only. Each handset is loaded with a daily sign in checklist and the crew leader will need to complete the checklist once upon signing in to the system. The assignment of a specific flight to a crew is automatically loaded into the handset module 160. The supervisor may assign the same service of a flight to two crews, thus the system 100 allows for more than one crew to be assigned to the same flight for the same service according to one embodiment of the invention. The information obtained from the communication server 110 is automatically populated on the handsets as a result of assignments, including flight number, concourse, gate, type of aircraft, type of service, service time, and whether or not a security search is needed for cabin service. The Estimated Time of Arrival (ETA) of the assigned flight, any change of ETA, and any change of gate is sent to the handset assigned to the flight. Upon arrival at the aircraft, the crew leader may signal, by means such as pressing a button or touching an icon on a touchscreen, to signal “Time On”—which is the time that the crew has arrived at the aircraft and started working on its assignment according to one embodiment of the invention. Upon completion of the tasks, the crew leader will similarly select a button or icon for “Time Off” to indicate the time of completion of an assignment. The handset module 160 prompts confirmation questions on a display on the handset to ensure the compliance of approved service procedures. When the crew leader selects the “Time Off” button, the block of the specific type of service for that flight is automatically removed from the dispatch window/GUI.

In one embodiment of the invention, the handset module 160 processes or handles the following information: assigned crew information, daily sign in checklist, assigned service, reports MTC problems, flight status change notifications, canned messaging (send and receive), reporting/communicating current location to the communication server 110 or a location server, quality assurance (QA) observation questions for the supervisor, and GSE notification (e.g., start and complete restock the truck). It should be noted that additional information may be added or deleted and the communicated information regarding flight status, crew status, locations, GSE, canned messaging, etc. may be modified by expansion/contraction of information.

In one embodiment of the invention, the crew information window/GUI is used to display and confirm crew PDA assignment is correct. In another embodiment of the invention, the daily sign in checklist displays items in sequence, such that a crew does not need to scroll up and down to find a specific item. The service window/GUI displays assigned service with flight information according to one embodiment of the invention. In one embodiment of the invention, an accept button may be selected to accept an assigned service, a start button may be selected to start a service, an MTC button may be selected to report an MTC problem, and a complete button may be selected to complete a service. In another embodiment of the invention, after a crew leader selects/clicks the “Complete” button, the system 100 will prompt confirmation questions to ensure the compliance of approved service procedures. In another embodiment of the invention, a crew leader must confirm the questions in order to complete the service. A crew leader may select a canned message from a list (e.g., a dropdown menu) to send a specific canned message to a dispatcher. Message windows may display messages from a dispatcher to a crew leader. In some embodiments of the invention, a flight status change notification window/GUI displays current flight status information. In another embodiment of the invention, Quality Assurance (QA) observation questions window/GUI are shown for a supervisor to record their observation. In some embodiments of the invention, GSE notification is displayed. In this embodiment of the invention, selection/clicking the Start button indicates the start of restocking a truck and selection/clicking the Complete button indicates completion of service on the aircraft. It should be noted that the start time and complete time is logged/recorded in the system 100.

In one embodiment of the invention, as all the handsets are GPS-enabled, the system will include a specific asset tracking module (i.e., a processor, software application or both) to collect GPS data from the handsets and process the data to feed the database 120 with proper GPS-related information. The Dispatcher workstation, including a dispatcher module 140, will have a display module 150 (i.e., a processor, software application, or both) with a map (i.e., stationary or moving) showing the terminal, gates, location of aircraft, and where each crew is located in real-time. The status of each crew is indicated on the map window/GUI to show if a crew is currently serving an aircraft or has finished the previous assignment. The dispatcher will be able to differentiate crews that are available for new assignments, crews that are currently working on assignments, and crews that are in the process of refilling supplies at the station (e.g., through color codes, markers, icons, etc.). Real-time positions of all the crews can be displayed on the map whenever they are outside of a building or aircraft according to one embodiment of the invention. When a handset is in an aircraft or a building where direct GPS satellite signals may not be available, the map will display its latest (i.e., last known) GPS position. In order to maximize battery life, the system may be set to stop GPS tracking of a specific handset when the crew is between services. In one embodiment of the invention, a Geographical Information System (GIS) is used to construct and display the detailed map of the airport, including the terminals, gates, supply stations, and any facility that is related to aircraft services. Such a map allows for precise presentation of locations of any crew or any aircraft to be displayed. In another embodiment of the invention, a separate utility for Position Validation is included in the system 100 to provide the specific function of checking the Time On and Time Off positions against the location of the assigned gate of each aircraft. When the crew leader presses the “Time On” button, the Position Validation utility compares the GPS position against the exact location of the assigned gate. If the GPS position matches the gate location within an appropriate distance, the record is marked with “GPS validated.” If the GPS position does not match the gate location, this field will be left blank implying no GPS validation. When the crew leader presses the “Time Off” button, the Position Validation utility checks if the GPS data is obtained within the past two minutes or any pre-determined amount of time. if the latest valid GPS data is obtained within the past two minutes or the pre-determined time and the position is within the appropriate distance from the assigned gate, the record is marked with “GPS validated.” If there is no GPS obtained at the time when Time Off is pressed, the system will continue to check GPS data, and if a valid GPS data is obtained within the next pre-determined time period, and its position matches the assigned gate, then the record will be marked with “GPS validated.” Otherwise the record will be left unmarked, implying no GPS validation.

In one embodiment of the invention, the map of the airport including the layout of terminals, gates, supply stations, facilities, etc. is displayed graphically in a window/GUI. In this embodiment of the invention, a point location outside of a gate denoting where the aircraft will stop is used for GPS validation. In another embodiment of the invention, a polygon delineating the boundary of the parking area at a gate can be used for the same purpose. A buffer polygon or circle illustrating an appropriate distance from the designated point location of each gate may be created. If the handset GPS position is within the buffer distance, the position is marked as “GPS Validated” in the database 120 according to one embodiment of the invention. At the time of validating the GPS position, if there is no GPS signal or if the GPS position is outside of the buffer distance, the position will not be marked with “GPS Validated.”

In one embodiment of the invention, when a flight has arrived at the gate, and the dispatcher has assigned one or more crews to provide services at that gate, an aircraft icon will appear on the displayed map by the gate. When all the services for that flight at that gate have been completed, the aircraft icon will automatically disappear from the map display, which assists in identifying completed services and saves communication time,

In one embodiment of the invention, a server designed for tracking vehicles, handsets, or any GPS devices is implemented to collect GPS positions from GPS-enabled handsets including handset module 160. The handset tracking server will collect GPS positions from handsets, send such information to the map window/GUI on the dispatch workstation for real-time display of handset locations. Whenever a handset is transmitting GPS position to the communication server 110, the map window/GUI will display its location in real time.

In one embodiment of the invention, a specifically designed Position Validation module (i.e., processor, software application, or both) is implemented to use the GPS data to validate the position of the specific crew. Whenever a handset sends a Time On or Time Off message to the system, the server will check the GPS position at the same time and then validate its GPS position. If validated, the record will be marked and kept in the database.

In another embodiment of the invention, in order to minimize the consumption of handset battery power, the GPS function can be automatically turned off at the completion of each assignment. When a new assignment is sent to a handset, the GPS function can be started automatically. In other words, as soon as the crew has received a job assignment, the handset will start collecting GPS data and sending valid GPS data to the communication server 110. As soon as the assignment is completed, the GPS function will be turned off to preserve battery power. This option can be disabled if battery life is not a concern.

In one embodiment of the invention, in order to maximize the use of the system database 120 that tends to grow substantially over time, an option for preserving storage capacity in the database 120 can be implemented to selectively store only those GPS data that are directly related to aircraft service activities. In other words, GPS data from all handsets that are not related to Time On or Time Off of a service, or any other significant service activity, can be filtered out.

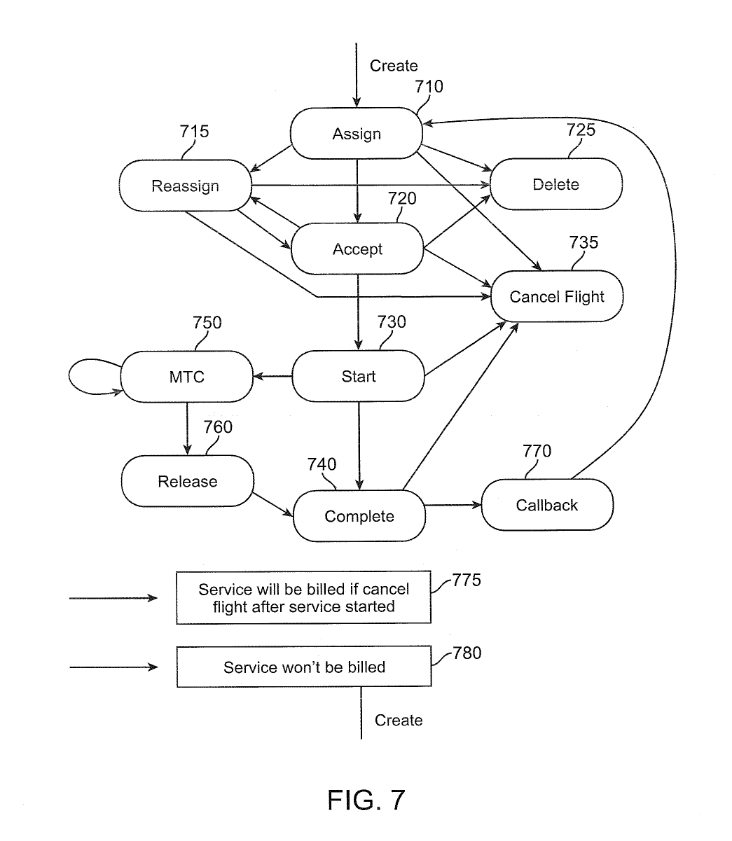

In one embodiment of the invention, the PS functions on the handset are transparent to the user. The functions on a dispatcher workstation are described above. FIG. 7 illustrates the system flow 700 of the three types of services, cabin, water, and lavatory. Other types of aircraft services can be incorporated into the same figure by adding those service components. A typical service flow can be summarized by the following.

As illustrated in FIG. 7, for the Assign function 710 is provided when a dispatcher assigns a service to an agent. The Accept function 720 is provided when an agent accepts the service assignment. The Start function 730 is provided when the agent starts servicing the aircraft. The Complete function 740 is provided when the agent completes servicing the aircraft. It should be noted, however, that there are circumstances that may effect the normal service flow. For instance, the reassign function 715 is provided as the dispatcher may reassign a service assignment to another agent due to the unexpected gate change of a specific flight, emergencies, illness, etc. The Delete function 725 is provided to delete an assigned service from the system 100. If a flight is canceled, the Canceled Flight function 735 amends the flight status and allows service assignments for the canceled flight to become moot until required. The MTC function 750 checks to see if the MTC has been met. If the MTC have been met, the system flow 700 continues to the Release function 760 where the crew may be released as having performed an acceptable service requirement via the Release function 76n. If the service crew needs to be called back, the Callback function 770 is invoked to callback status for the crew to return to the previous assigned aircraft and perform any required service that has either not been completed, not completed satisfactorily, an additional service is needed, etc. Once the service has been initiated, if the flight is canceled, the service fee will be billed through the Billing service function 775, where the fee information is transmitted through the communications server 110 to the database 120 so that reports may be generated. If a flight is canceled before a service is initiated, the service fee will not be billed and the Non-fee billing function 780 is invoked to update the database 120 so that the service fee is not billed to the client.

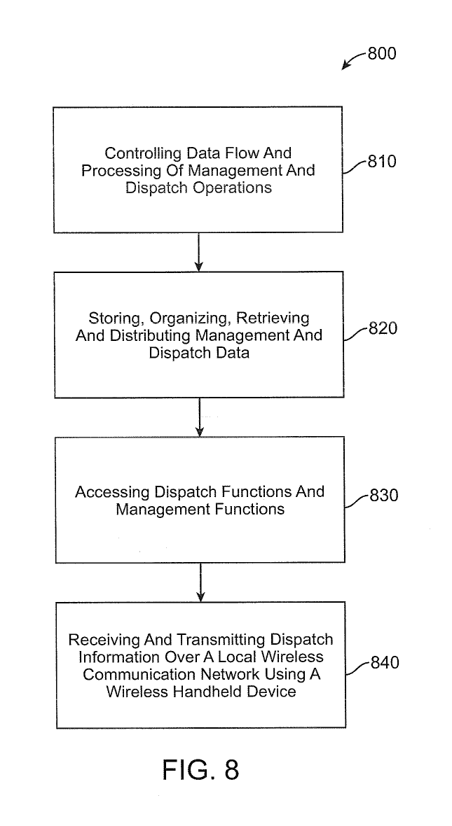

FIG. 8 illustrates a block diagram for a process 800 for a real-time management and dispatch system. In one embodiment of the invention, in block 810, the process provides controlling data flow and processing of management and dispatch operations with a controller processor, such as controller processor 115. In block 820, process 800 provides storing, organizing, retrieving and distributing of management and dispatch data using a database server, such as database server 125 or communications server 110.

In block 830, process 800 provides accessing dispatch functions and management functions through a workstation. Block 840 provides for receiving and transmitting dispatch information over a local wireless communication network using a wireless handheld device including a handset module 160. In this embodiment of the invention, the process 800 provides for real-time information to be transmitted between a controller processor 115 in a communication server 110, the work station, and the handheld device including the handset module 160. It should be noted that in some embodiments of the invention, process 800 performs functionality of system 100 including information processing, display processing, report generation and processing, administration processing, dispatch processing, status processing, flight information processing, management processing, etc.

The present invention is designed to automate the dispatch operations of aircraft services in order to substantially enhance the efficiency of service. The system will provide real time information of flight schedule, flight changes, the gate locations where services are required, the current locations of available service crews, real-time communications about status and availability between service teams and dispatchers, access to all the information from multiple dispatchers, access to the designated service assignment by each service crew through handheld devices, and the reporting functions needed for both management functions and billing purposes.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. The embodiments of the invention can take the form of an entirely hardware embodiment, an entirely software embodiment or an embodiment containing both hardware and software elements. In a preferred embodiment, the invention is implemented in software, which includes but is not limited to, firmware, resident software, microcode, etc.

Furthermore, the embodiments of the invention can take the form of a computer program product accessible from a computer-usable or computer-readable medium providing program code for use by, or in connection with, a computer, processing device, or any instruction execution system. For the purposes of this description, a computer-usable or computer readable medium can be any apparatus that can contain, store, communicate, or transport the program for use by, or in connection with, the instruction execution system, apparatus, or device. The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read-only memory (CD-ROM), compact disk-read/write (CD-R/W) and DVD.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters. In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

The terms “computer program medium,” “computer usable medium,” “computer readable medium,” and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information, from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor or multi-core processor to perform the features of the computer system. Accordingly, such computer programs represent controllers of the computer system.

Generally, the term “computer-readable medium”, as used herein, refers to any medium that participated in providing instructions to a processor for execution. Such a medium may take many forms, including but not limited to, non-volatile media, volatile media and transmission media. Non-volatile media includes, for example, optical or magnetic disks. Volatile media includes dynamic memory. Transmission media includes coaxial cables, copper wire and fiber optics, including the wires that comprise a bus.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, or any other medium from which a computer can read.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A real-time management and dispatch system comprising:
a controller configured to control data flow and processing of management and dispatch operations;
a database server configured to control storage, organization, retrieval, and distribution of management and dispatch data;
at least one workstation configured for accessing dispatch functions and management functions; and
at least one Global Positioning System (GPS) enabled handheld device configured to receive and transmit dispatch information over a local wireless communication network,
wherein the local wireless communication network provides real-time information transmission between the controller, at least one work station, and the at least one handheld device.

2. The system of claim 1, wherein the controller comprises a server that continuously runs, the server including:
a web service module configured to provide administrative functions for creation, editing and deletion of user accounts for a plurality of users having access to the system with different level of privileges based on user information, and for creation and managing service crew information;
a reporting module configured for retrieving service information from the database server and creating crew performance evaluation reports, evaluating efficiency of operation and billing reports;
a wireless communication module configured to manage wireless communication between handsets assigned to service crews and the database server;
a system communication module configured to handle requests coming from dispatch workstations and to retrieve relevant information from the database server and process the information to respond to the requests; and
a location validation module configured to analyze incoming GPS information from any handset, filter out invalid GPS information, match Time On or Time Off status of a crew, compare the GPS information of a crew's assigned aircraft and gate, and determine whether a GPS position is consistent with a location of a crew assignment.

3. The system of claim 1, wherein the database server includes a standard database management system.

4. The system of claim 3, wherein the database server is configured to process real-time queries to retrieve related data for dispatch operations, process queries to create reports for management and billing, process real-time GPS information to filter out invalid GPS records, and to match incoming GPS information to a corresponding service crew.

5. The system of claim 4, wherein the database server is configured to record current status of each service crew and each aircraft to be serviced, and historical records of all services that have been performed.

6. The system of claim 1, wherein flight information is inputted into the database server in real-time through one of a direct database link, imported from a carrier's network, and manually entered.

7. The system of claim 6, wherein the flight information includes type of aircraft, types of services requested, current status of arrival time, arrival flight number, arrival gate assigned, departure time, departure flight number, departure gate assigned.

8. The system of claim 1, wherein the at least one workstation is configured to display status of any aircraft needing services or currently being serviced, display gate location of each aircraft that needs any type of services or that is currently being serviced, display current GPS position of any service crew assigned a task, either in the process of moving to a gate where an assigned aircraft is located or at the gate performing services, display status of all available service crews that can be assigned a next task, provide a dispatch function for assigning any task to any available crew, revise assignments due to flight delays, and gate changes, generate reports showing service records of any service crew, at any gate, or all services performed during any specific period of time, and create and edit any service crew in the system with information of each crew member.

9. The system of claim 1, wherein the system responds automatically to any flight change in real time, including change of arrival time and arrival gate, departure time and departure gate, and change of aircraft due to mechanical reasons or scheduling changes.

10. The system of claim 1, wherein the workstation enables a dispatcher to assign service to a crew based on the crew's qualification and classified service type.

11. The system of claim 10, wherein aircraft services includes adding water, cleaning and lavatory services.

12. The system of claim 10, wherein the system automatically differentiates crews by qualification and service types and will not allow the workstation to assign a crew to a wrong service type or wrong qualification.

13. The system of claim 12, wherein the workstation is configured to enable a dispatcher to assign services to crews according to an amount of time available for a service to be completed before departure of an aircraft, wherein service priority is assigned based on a time frame to complete the assigned services before departure.

14. The system of claim 13, wherein the workstation is configured to enable the dispatcher to assign services to crews currently available and closest distance to a gate where the services will be performed based on GPS position of each crew.

15. The system of claim 14, wherein the system displays current or latest position of each crew on a map, and displays gate locations where different types of services are needed, and each task is assigned to an available and qualified crew that is closest to a gate location where services are needed.

16. The system of claim 14, wherein the dispatch workstation is configured to display records of past services that are performed by any specific crew or by all crew at any time and to identify crews that perform tasks more effectively and efficiently than other crews.

17. The system of claim 1, wherein the handheld device is configured to receive and transmit current assignments and transmit current status of a crew.

18. The system of claim 17, wherein the handheld device is further configured to enable a member of a crew to receive an assignment of an aircraft service or to receive an assignment change in real time.

19. The system of claim 18, wherein upon assignment of a task to the handheld device, the device transmits an alert signal and a prompt for the crew member to acknowledge and accept the assignment.

20. The system of claim 1, wherein the handheld device is configured to enable a dispatcher to determine in real time where a crew assigned a task is currently

21. The system of claim 20, wherein the handheld device is further configured to enable the system to automatically determine if the crew has arrived at a designated gate for an assignment by comparing a GPS position against a gate location.

22. The system of claim 21, wherein the handheld device is further configured to enable the system to automatically determine at what time each assigned crew arrived at the gate to provide service.

23. The system of claim 22, wherein the handheld device is configured to enable the dispatcher to determine whenever a crew has completed an assignment at a gate.

24. The system of claim 1, wherein the system is configured to generate reports of any crew or all crews about their performance in terms of time needed to provide a specific type of service for each type of aircraft.

25. A real-time management and dispatch system method comprising:
controlling data flow and processing of management and dispatch operations with a controller processor;
storing, organizing, retrieving and distributing management and dispatch data using a database server;
accessing dispatch functions and management functions through a workstation; and
receiving and transmitting dispatch information over a local wireless communication network using a wireless handheld device,
wherein real-time information is transmitted between the controller processor, the work station, and the handheld device.

26. The method of claim 25, wherein controlling further comprises:
providing administrative functions for creating, editing and deleting of user accounts for a plurality of users having access to the system with different level of privileges based on user information, and for creating and managing service crew information;
retrieving service information from the database server and creating crew performance evaluation reports and billing reports;
evaluating efficiency of operation;
managing wireless communication between handsets assigned to service crews and the database server;
handling requests coming from dispatch workstations and retrieving relevant information from the database server and processing the information to respond to the requests; and
analyzing incoming GPS information from any handset, filtering out invalid GPS information, matching Time On or Time Off status of a crew, comparing the GPS information of a crew's assigned aircraft and gate, and determining whether a GPS position is consistent with a location of a crew assignment.

27. The method of claim 25, further comprising:
recording current status of each service crew and each aircraft to be serviced, and historical records of all services that have been performed.

28. The method of claim 25, further comprising:
displaying real-time status of any aircraft needing services or currently being serviced;
displaying gate location of each aircraft that needs any type of services or that is currently being serviced;
displaying current GPS position of any service crew assigned a task, either in the process of moving to a gate where an assigned aircraft is located or at the gate performing services;
displaying status of all available service crews that can be assigned a next task, provide a dispatch function for assigning any task to any available crew;
revising assignments due to flight delays, and gate changes;
generating reports showing service records of any service crew, at any gate, or all services performed during any specific period of time; and
creating and editing any service crew in the system with information of each crew member.

29. The method of claim 25, further comprising:
automatically responding to any flight change in real time, including change of arrival time and arrival gate, departure time and departure gate, and change of aircraft due to mechanical reasons or scheduling changes.

30. The method of claim 29, further comprising:
automatically differentiating crews by qualification and service types and will not allow the workstation to assign a crew to a wrong service type or wrong qualification.

31. The method of claim 25, further comprising:
assigning services to crews according to an amount of time available for a service to be completed before departure of an aircraft, wherein service priority is assigned based on a time frame to complete the assigned services before departure.

32. The method of claim 25, further comprising:
assigning services to crews currently available and closest distance to a gate where the services will be performed based on GPS position of each crew.

33. The method of claim 32, further comprising:
displaying current or latest position of each crew on a map;
displaying gate locations where different types of services are needed; and
assigning each task an available and qualified crew that is closest to a gate location where services are needed.

34. The method of claim 33, further comprising:
automatically determining if the crew has arrived at a designated gate for an assignment by comparing a GPS position against a gate location.

35. The method of claim 33, further comprising:
automatically determining at what time each assigned crew arrived at the gate to provide service.

36. A computer program product for providing management and dispatching aircraft services, comprising a computer usable medium including a computer readable program comprising program instructions, wherein the computer readable program when executed on a computer causes the computer to:
control data flow and processing of management and dispatch operations with a controller processor; store, organize, retrieve and distribute management and dispatch data using a database server;
access dispatch functions and management functions through a workstation; and
receive and transmitting dispatch information over a local wireless communication network using a wireless handheld device,
wherein real-time information is transmitted between the controller processor, the work station, and the handheld device.
